(19) United States
(12) Patent Application Publication
(10) Pub. No.: US 2005/0124723 A1
(43) Pub. Date: Jun. 9, 2005

(54) Non-aqueous wood preservatives

(76) Inventors: Joachim Fritschi, Lorrach (DE); Florian Lichtenberg, Grenzach-Wyhlen (DE); Hans-Norbert Marx, Buhl (DE)

Correspondence Address: FISHER, CHRISTEN & SABOL, 1725 K STREET, N.W., SUITE 1108, WASHINGTON, DC, 20006, US

(21) Appl. No.: 10/503,732

(22) PCT Filed: Feb. 4, 2003
(86) PCT No.: PCT/EP03/01079

(30) Foreign Application Priority Data
Feb. 7, 2002 (EP) 02002799.1

(51) Int. Cl. C08K 3/00

(52) U.S. Cl. 523/122

(57) ABSTRACT

A wood preservative, characterized in that it includes (a) 0.5 to 50 parts of a biocidal quaternary ammonium compound or of a mixture of biocidal quaternary ammonium compounds; (b) 0.5 to 50 parts of an aliphatic or cycloaliphatic carboxylic acid having 6 to 30 carbon atoms, or a mixture of such carboxylic acids; (c) 0 to 5 parts of additional biocidal substances; (d) 0 to 20 parts of one or more binders, colorants and/or pigments; (e) 0 to 20 parts of one or more additives for imparting hydrophobicity, moisture regulation and/or drying; and (f) 40 to 99 parts of a nonpolar organic solvent, with the proviso that the ratio between components (a) and (b) is between 1:3 and 3:1.

The invention relates to nonaqueous wood preservatives based on biocidal quaternary ammonium compounds and carboxylic acids and to their use for the treatment of dried and/or treated woods, and to the resulting protected woods.

Quaternary ammonium compounds have been known, and used extensively, since the 30s of the 20^{th} century as efficient bactericides and fungicides in the fields of pharmacology, disinfection and preservation. The broad activity spectrum is also exploited in the protection of materials, in particular in the field of wood preservation. Owing to the fact that the quaternary ammonium compounds are readily soluble in water, they are found almost exclusively in water-based preparations, alone or in combination with other active compounds, for example copper compounds, in what are known as ACQ salts. Owing to their ionic character, quaternary ammonium compounds are only sparingly soluble, or insoluble, in nonpolar solvents such as, for example, white spirit or petroleum. However, preparations which are based on the abovementioned mineral oil derivatives are very important in the protection of wood, in particular when dry woods whose dimensional stability is of great importance must be subjected to protective treatment. Examples of such woods are glued laminated board (laminate glue), doors, windows, construction timber (prefabs) and the like. To date, an economic application of quaternary ammonium compounds in this sector has not been possible since sufficient solubility of quaternary ammonium compounds, for example in white spirit (b.p. 180-220° C.) could only be achieved by means of large amounts of solubilizers or emulsifiers. Such additives sometimes have a considerable effect on the characteristics of the preparations, for example the water absorption capacity or the leachability in the case of the use of emulsifiers. Also, the paintability and the aging behavior of the surfaces treated thus may be adversely affected.

It was therefore an object of the present invention to provide wood preservatives based on quaternary ammonium salts which comprise nonpolar solvents such as, for examples white spirit, without large amounts of added solubilizers or emulsifiers and which can thus also be employed in the case of mechanically finished woods without adverse affects on dimensional stability, surface quality, varnishability and environmental friendliness.

The object is achieved according to the invention by the wood preservatives as claimed in patent claim 1.

Surprisingly, it has been found that the addition of aliphatic or cycloaliphatic carboxylic acids having 6 to 30 carbon atoms, or a mixture of such carboxylic acids, without further adjuvants allows the solubility of quaternary ammonium compounds in nonpolar organic solvents such as, for example, white spirit, to be increased to such an extent that functional and economical formulations for use with wood can be prepared.

The wood preservatives according to the invention comprise 0.5 to 50 parts (by weight) of a biocidal quaternary ammonium compound or of a mixture of such compounds and 0.5 to 50 parts of an aliphatic or cycloaliphatic carboxylic acid having 6 to 30 carbon atoms, or a mixture of such carboxylic acids, with the proviso that the ratio of quaternary ammonium compound and carboxylic acid is in the range of from 1:3 to 3:1, and 10 to 99 parts of a nonpolar organic solvent if appropriate, they may also comprise further additions, viz. in particular
up to 5 parts of additional biocidal substances such as fungicides, insecticides, molluscicides or bactericides,
up to 20 parts of one or more binders, colorants or pigments,
up to 20 parts of one or more additives for imparting hydrophobicity, moisture regulation and/or drying (desiccants).

Biocidal quaternary ammonium compounds which are preferably employed are those of the general formula

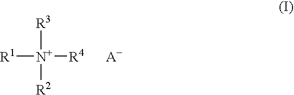

In this formula, R¹ is benzyl or C₆₋₁₈-alkyl,
R² is C₁₋₁₈-alkyl or —[(CH₂)₂—O]ₙR⁵ where n=1-20,
R³ and R⁴ independently of one another are C₁₋₄-alkyl,
R⁵ is hydrogen or optionally substituted phenyl
   and A⁻ is a monovalent anion or an equivalent of a polyvalent anion of an inorganic or organic acid.

Alkyl here and in the following text is understood as meaning in each case linear or branched alkyl groups with the stated number of carbons, with preference linear alkyl groups and especially preferably those with an even number of carbon atoms. Alkyl is understood as meaning in particular also the homolog mixtures derived from natural raw materials, such as, for example, “cocoalkyl”.

Substituted phenyl is understood as meaning in particular phenyl groups which are substituted by one or more C₁₋₈-alkyl groups and/or by one or more chlorine atoms.

Suitable anions A⁻ are, in principle, all inorganic or organic anions, in particular halide such as, for example, chloride or bromide, borate or anions of lower carboxylic acids such as, for example, acetate, propionate or lactate.

Especially preferred as quaternary ammonium compound (I) are didecyldimethylammonium salts, dioctyldimethyl ammonium salts, octyldecyldimethylammonium salts, dicocoalkyldimethylammonium salts, cocoalkyldimethylpoly(oxyethyl)ammonium salts, dicocoalkylmethylpoly(oxyethyl)ammonium salts, decyldimethylpoly(oxyethyl)ammonium salts, didecylmethylpoly(oxyethyl)ammonium salts, octyldimethylpoly(oxyethyl)ammonium salts, dioctylmethylpoly(oxyethyl)ammonium salts, cocoalkyldimethylbenzylammonium salts, benzyldodecyldimethylammonium salts, benzyldimethylpoly(oxyethyl)ammonium salts, C₈₋₁₈-alkyltrimethylammonium salts, and mixtures of two or more of these compounds.

Aliphatic or cycloaliphatic carboxylic acids having 6 to 30 carbon atoms which are employed by preference are saturated or unsaturated natural or synthetic fatty acids, or the cycloaliphatic carboxylic acids known under the name “naphthenic acids” and mixtures of those carboxylic acids. They include in particular the fatty acids and fatty acid mixtures which can be obtained from natural fats and fatty oils, such as, for example, coconut, linseed and soya fatty acids.

Nonpolar organic solvents which are employed by preference are aliphatic or cycloaliphatic hydrocarbons or their mixtures. These include, for example, the commercially available high-boiling hydrocarbon fractions known under the names light gasoline, heavy naphtha or white spirit and products such as petroleum and decalin.

Heavy mineral oils may also be used as solvents for external applications.

The wood preservatives according to the invention penetrate the wood to be treated rapidly and to great depth; the dimension and surface structure remain unaltered. They are distinguished inter alia by the fact that the quaternary ammonium compounds which are bound in salt-like form cannot evaporate from the substrate, owing to their nonvolability, thus causing neither a loss of activity nor an adverse effect on the environment owing to emitted active ingredient.

The wood preservatives according to the invention can be employed for all treatment methods conventionally used in wood protection, such as painting, spraying, dipping and (pressure) impregnation. They are preferably used for the treatment of dry woods by painting, dipping or impregnation.

The use of the compositions according to the invention is not limited to woods; they are likewise suited for the preservation of other porous organic substrates such as, for example, papers, board, cork and the like.

The invention likewise relates to woods obtainable by treatment with the wood preservatives according to the invention which have been treated by way of protection with biocidal quaternary ammonium compounds with addition of aliphatic or cycloaliphatic carboxylic acids having 6 to 30 carbon atoms or a mixture of such carboxylic acids.

The invention furthermore comprises the use of the combination of biocidal quaternary ammonium compounds with aliphatic or cycloaliphatic carboxylic acids having 6 to 30 carbon atoms in a mass ratio of from 1:3 to 3:1 for the preservation of nonpolar fluids. These include, in particular, drilling and cutting oils, cooling lubricants, hydraulic liquids and mineral oil-based fuels and lubricants. In the presence of water, and without preserving additives, these fluids are readily contaminated with, and degraded by, microorganisms, which can lead to the formation of slime, malodors, corrosion and corresponding subsequent damage.

The examples which follow illustrate the practice of the invention, without this constituting a limitation. All amounts stated in “parts” are mass related parts (by weight).

### EXAMPLE 1

A wood preservative composition was prepared in accordance with the following formula:
6.0 parts of didecyldimethylammonium chloride
4.0 parts of soya fatty acid
90.0 parts of white spirit, type D 60, b.p. 180-220° C.

At an application rate of 150 g/m² wood surface, the product was active against rots as specified in DIN EN 113.

### EXAMPLE 2

A wood preservative composition was prepared in accordance with the following formula:
6.0 parts of benzalkonium chloride
3.0 parts of undecenoic acid
0.5 part of propiconazole
0.5 part of diethylene glycol monobutyl ether
90.0 parts of petroleum, b.p. 200° C.

At an application rate of 120 g/m² wood surface, the product was active against rots and bluing fungi as specified in DIN EN 113 and DIN EN 152.

### EXAMPLE 3

A wood preservative composition was prepared in accordance with the following formula:
5.0 parts of didecyldimethylammonium chloride
5.0 parts of linseed oil fatty acid
0.5 part of iodopropynyl butylcarbamate (IPBC)
10.0 parts of linseed-oil-based alkyd resin (oil length 80%)
79.5 parts of white spirit, b.p. >150° C.

At an application rate of 120 g/m² wood surface, the product was active against rots and bluing fungi as specified in DIN EN 113 and DIN EN 152 and against the growth of mosses, algae and lichens on this surface.

### EXAMPLE 4

A wood preservative composition was prepared in accordance with the following formula:
10.0 parts of N,N-didecyl-N-methylpoly(oxethyl)ammonium propionate (70% strength solution in ethylene glycol)
7.0 parts of coconut fatty acid
5.0 parts of copper naphthenate (10% Cu)
10.0 parts of colophonium resin
68.0 parts of petroleum, b.p. >200° C.

At an application rate of 100 g/m² wood surface, the product was active against attack by mold, blueness, algae, mosses and lichens, or their growth on this surface.

At an application rate of 250 g/m² wood surface, the product was additionally active against soft rot.

### EXAMPLE 5

A wood preservative composition was prepared in accordance with the following formula:
12.0 parts of didecyldimethylammonium chloride
10.0 parts of naphthenic acid, technical grade
10.0 parts of copper naphthenate
63.0 parts of heavy mineral oil, b.p. >350° C.
5.0 parts of 2,4-dinitro-o-cresol

At an application rate of 200-250 g/m² wood surface, the product was suitable for the aftercare of wood in permanent contact with the soil (for example utility poles).

### EXAMPLE 6

A wood preservative composition was prepared in accordance with the following formula:
3.0 parts of N,N-didecyl-N-methylpoly(oxethyl)ammonium propionate (70% strength solution in ethylene glycol)
2.0 parts of undecenoic acid
0.5 part of propiconazole
5.0 parts of hardened colophonium resin
0.5 part of oil-soluble colorant
89.0 parts of white spirit, deodorized, A III

At a treatment rate of 20 kg/m³ wood (vac-vac method), the product was active against rot and bluing fungi.

### EXAMPLE 7

A wood preservative composition (concentrate) was prepared in accordance with the following formula:
25.0 parts of didecyldimethylammonium chloride
15.0 parts of distilled coconut fatty acid
3.0 parts of iodopropynyl butylcarbamate (IPBC)
10.0 parts of zinc octoate (22% zinc)
57.0 parts of petroleum, b.p. >250° C.

Prior to use, the concentrate is to be diluted 1:9 with petroleum or white spirit.

At an application rate of 200 g/m² wood surface, the dilution was active against rot, bluing fungi, molds and soft rots.

### EXAMPLE 8

A wood preservative composition was prepared in accordance with the following formula:
2.0 parts of didecyldimethylammonium chloride
2.0 parts of N,N-bis(3-aminopropyl)dodecylamine (Lonzabac® 12.100)
4.0 parts of tall oil fatty acid
0.5 part of propiconazole
5.0 parts of hydrocarbon resin, m.p. >80° C., gasoline-soluble
0.5 part of phenoxycarb, dissolved 1:19 in diethylene glycol monobutyl ether
85.0 parts of white spirit, isoparaffinic, b.p. >180° C.

At a treatment rate of 20 kg/m³ wood or an application rate of 150 g/m² wood surface, the composition was active against wood-destroying fungi and insects and against bluing fungi and molds.

1. A wood preservative, characterized in that it comprises
a) 0.5 to 50 parts of a biocidal quaternary ammonium compound or of a mixture of biocidal quaternary ammonium compounds
b) 0.5 to 50 parts of an aliphatic or cycloaliphatic carboxylic acid having 6 to 30 carbon atoms, or a mixture of such carboxylic acids
c) 0 to 5 parts of additional biocidal substances
d) 0 to 20 parts of one or more binders, colorants and/or pigments
e) 0 to 20 parts of one or more additives for imparting hydrophobicity, moisture regulation and/or drying and
f) 40 to 99 parts of a nonpolar organic solvent,
with the proviso that the ratio between components a) and b) is between 1:3 and 3:1.

2. A wood preservative as claimed in claim 1, characterized in that the biocidal quaternary ammonium compound employed is a compound of the formula: 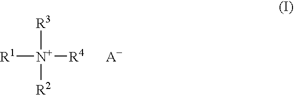
in which
R¹ is benzyl or C₆₋₁₈-alkyl,
R² is C₁₋₁₈-alkyl or —[(CH₂)₂—O]ₙR⁵ where n=1-20,
R³ and R⁴ independently of one another are C₁₋₄-alkyl,
R⁵ is hydrogen or optionally substituted phenyl
and A⁻ is a monovalent anion or an equivalent of a polyvalent anion of an inorganic or organic acid.

3. A wood preservative as claimed in claim 1, characterized in that it comprises 2 to 15 parts of quaternary ammonium compound(s) and 1 to 10 parts of carboxylic acid(s).

4. A wood preservative as claimed in claim 1, characterized in that the nonpolar organic solvent employed is an aliphatic or cycloaliphatic hydrocarbon or a mixture of such hydrocarbons.

5. The use of the wood preservative as claimed in claim 1 for the treatment of dry woods by painting, dipping or impregnation.

6. Wood which has been treated by way of protection with biocidal quaternary ammonium compounds with addition of aliphatic or cycloaliphatic carboxylic acids having 6 to 30 carbon atoms, obtainable by treating wood with a wood preservative as claimed in claim 1.

7. The use of biocidal quaternary ammonium compounds in combination with aliphatic or cycloaliphatic carboxylic acids having 6 to 30 carbon atoms in a mass ratio of from 1:3 to 3:1 for the preservation of nonpolar fluids, in particular drilling and cutting oils, cooling lubricants, hydraulic liquids and mineral oil-based fuels and lubricants.

8. The use as claimed in claim 7, characterized in that the biocidal quaternary ammonium compound employed is a compound of the formula: 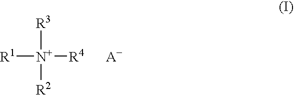
in which R¹, R², R³, R⁴ and A⁻ have the meanings mentioned in claim 3.

9. A wood preservative as claimed in claim 2, characterized in that it comprises 2 to 15 parts of quaternary ammonium compound(s) and 1 to 10 parts of carboxylic acid(s).

10. A wood preservative as claimed in claim 2, characterized in that the nonpolar organic solvent employed is an aliphatic or cycloaliphatic hydrocarbon or a mixture of such hydrocarbons.

11. A wood preservative as claimed in claim 3, characterized in that the nonpolar organic solvent employed is an aliphatic or cycloaliphatic hydrocarbon or a mixture of such hydrocarbons.

12. The use of the wood preservative as claimed in claim 2 for the treatment of dry woods by painting, dipping or impregnation.

13. The use of the wood preservative as claimed in claim 3 for the treatment of dry woods by painting, dipping or impregnation.

14. The use of the wood preservative as claimed in claim 4 for the treatment of dry woods by painting, dipping or impregnation.

15. Wood which has been treated by way of protection with biocidal quaternary ammonium compounds with addition of aliphatic or cycloaliphatic carboxylic acids having 6 to 30 carbon atoms, obtainable by treating wood with a wood preservative as claimed in claim 2.

16. Wood which has been treated by way of protection with biocidal quaternary ammonium compounds with addition of aliphatic or cycloaliphatic carboxylic acids having 6 to 30 carbon atoms, obtainable by treating wood with a wood preservative as claimed in claim 3.

17. Wood which has been treated by way of protection with biocidal quaternary ammonium compounds with addition of aliphatic or cycloaliphatic carboxylic acids having 6 to 30 carbon atoms, obtainable by treating wood with a wood preservative as claimed in claim 4.
